(19) United States
(12) Patent Application Publication
(10) Pub. No.: US 2021/0212537 A1
(43) Pub. Date: Jul. 15, 2021

(54) VACUUM CLEANER

(71) Applicant: Samsung Electronics Co., Ltd., Suwon-si (KR)

(72) Inventors: Youngjun CHO, Suwon-si (KR); Byeongwoo AHN, Suwon-si (KR); Jonggook LIM, Suwon-si (KR)

(21) Appl. No.: 17/272,282

(22) PCT Filed: Jun. 27, 2019
(86) PCT No.: PCT/KR2019/007814

§ 371 Date: Feb. 26, 2021

(30) Foreign Application Priority Data
Aug. 30, 2018 (KR) 10-2018-0102910

(51) Int. Cl. A47L 9/12; A47L 9/16; B01D 46/16; B01D 46/24; B01D 46/00

(52) U.S. Cl. CPC A47L 9/122; A47L 9/127; A47L 9/1683; B01D 46/16; B29L 2031/14; B01D 46/0001; B01D 2265/04; B01D 2279/55; B01D 46/2403

(57) ABSTRACT

Provided is a vacuum cleaner. The vacuum cleaner includes: a driver; a suctioner configured to suck external air by the driver; a discharger configured to discharge the sucked air to the outside; and a filter including a first filter provided in a flow path between the suctioner and the discharger to separate dust from the sucked air and having a first surface, a second filter having a second surface surrounding an outer circumference of the first surface, and a joint configured to join the first surface and a seam contacting the second surface.

### CROSS-REFERENCE TO RELATED APPLICATIONS

This application is a 371 of International Application No. PCT/KR2019/007814 filed on Jun. 27, 2019, which claims priority to Korean Patent Application No. 10-2018-0102910 filed on Aug. 30, 2018, the disclosures of which are herein incorporated by reference in their entirety.

### BACKGROUND

### 1. Field

The disclosure relates to a vacuum cleaner, and more specifically, to a vacuum cleaner with an increased cross-sectional area of a filter.

### 2. Description of Related Art

A vacuum cleaner sucks foreign objects such as dust on a surface to be cleaned, along with the surrounding air, and then filters and collects the foreign objects through a dust collector or a filter. In particular, a cyclone vacuum cleaner forms a rotating airflow in the air and uses a centrifugal force generated by the rotation of the air to separate the foreign objects from the air, and has the advantage of being semi-permanently used because the cyclone vacuum cleaner does not require a dust bag.

On the other hand, in recent years, the release of handy type vacuum cleaners or stick type vacuum cleaners with enhanced portability is increasing. The overall size of the handy type or stick type vacuum cleaner is smaller than that of the existing vacuum cleaner. Accordingly, a cross-sectional area of the filter provided in the handy type or stick type vacuum cleaner is smaller than that of the existing vacuum cleaner.

However, when the cross-sectional area of the filter is small, even if the vacuum cleaner is used only a few times, the filter becomes clogged with foreign objects and the suction force of the vacuum cleaner decreases. In order to solve this problem, the user of the vacuum cleaner needs to remove the foreign objects stuck in the filter directly. The smaller the cross-sectional area of the filter, the more inconvenient the user needs to remove the foreign objects stuck in the filter more often.

Accordingly, an object of the disclosure is to provide a vacuum cleaner with an increased cross-sectional area of a filter.

### SUMMARY

According to an aspect of the present disclosure, a vacuum cleaner includes: a driver; a suctioner configured to suck external air by the driver; a discharger configured to discharge the sucked air to the outside; and a filter including a first filter provided in a flow path between the suctioner and the discharger to separate dust from the sucked air and having a first surface, a second filter having a second surface surrounding an outer circumference of the first surface, and a joint configured to join the first surface and a seam contacting the second surface.

Accordingly, the time when the user may use the vacuum cleaner 1 without washing the filter 40 increases, and thus the user convenience is improved.

The first surface of the first filter may be provided in a disk shape, and the second surface of the second filter may be provided in a cylindrical shape.

Accordingly, it is possible to maximize the cross-sectional area of the filter 40 within a predetermined space.

The first filter may be provided so that an edge portion of the first surface covers an edge portion of the second surface at the seam contacting the second surface.

A joint 43 of the filter may be formed by being injection-molded of a material having a deformation recovery force of a predetermined or more.

Accordingly, a connection part of the first filter 41 and the second filter 42 has a deformation recovery force, and thus may not be affected by the change in the shape of the filter 40 while the user of the vacuum cleaner 1 washes the filter 40 and may be restored to its original state again even if the shape of the filter 40 is deformed, so the user may more easily clean the filter 40 and the life of the filter 40 may increase.

The joint of the filter may be made of a rubber or polyurethane material.

The filter may be provided by being injection-molded toward an upper side of the edge portion of the first surface of the first filter covering the edge portion of the second surface of the second filter.

Accordingly, an adhesion between the first filter 41 and the second filter 42 is improved.

At least one of the first filter and the second filter may include: a micro filter; and a mesh member that is provided on at least one of both surfaces of the micro filter.

Accordingly, the micro filter constituting the filter 40 may be supported and protected by the mesh member, so the life of the filter 40 increases.

The micro filter and the mesh member may be fused to each other by ultrasonic waves.

Accordingly, a contact force between the filter and the mesh member is improved.

The filter may further include, on a side opposite to the first surface, a frame coupled in a circumferential shape to an edge portion of an opening formed by the second surface.

Accordingly, as the filter 40 is finished by a frame 44, the filter 40 may be more robust, and may also be easily fastened to and detached from other components.

The frame may be injection-molded of a material having a higher strength than the joint of the filter.

The filter may further include a support part that is disposed in a space accommodated by the first filter and the second filter.

Accordingly, even if the air sucked through the suctioner 20 passes through the filter 40 at a high speed while being discharged through the discharger 30, the first surface of the first filter 41 and the second surface of the second filter 42 may maintain their original shapes by the support of the support part 45 to smoothly perform the function as the filter.

A cyclone dust collector may be provided in the flow path through which the air sucked through the suctioner enters the filter.

Accordingly, dust having a large size is primarily filtered by the cyclone dust collector 70 in front of the filter 40, and thus dust having a relatively smaller size may be secondarily separated from the filter 40, so the washing cycle of the filter 40 is further reduced.

According to the disclosure, it is possible to increase the cross-sectional area of the filter in the vacuum cleaner.

### BRIEF DESCRIPTION OF THE DRAWINGS

FIG. 1 is a perspective view of a vacuum cleaner according to an embodiment of the disclosure.

FIG. 2 is a perspective view of a body of the vacuum cleaner according to the embodiment of the disclosure.

FIG. 3 is a perspective view of a filter unit of the vacuum cleaner according to the embodiment of the disclosure.

FIG. 4 is an exploded perspective view of the filter unit of the vacuum cleaner according to the embodiment of the disclosure.

FIG. 5 is a diagram illustrating a first filter and a second filter of the filter unit of the vacuum cleaner according to the embodiment of the disclosure.

FIG. 6 is a diagram illustrating a cut surface of the filter unit of the vacuum cleaner according to the embodiment of the disclosure.

FIG. 7 is a diagram illustrating an example of a process of manufacturing a filter unit by a first method.

FIG. 8 is a diagram illustrating another example of the process of manufacturing a filter unit by the first method.

FIG. 9 is a diagram illustrating an example of a process of manufacturing a filter unit by a second method.

FIG. 10 is a diagram illustrating another example of the process of manufacturing a filter unit by the second method.

FIG. 11 is a diagram illustrating a detailed configuration of a first filter unit or a second filter unit according to the embodiment of the disclosure.

FIG. 12 is a diagram illustrating the cut surface of the body of the vacuum cleaner according to an embodiment of the disclosure.

FIG. 13 is an exploded perspective view of the main body of the vacuum cleaner according to the embodiment of the disclosure.

FIG. 14 is a diagram illustrating an air flow in the vacuum cleaner according to the embodiment of the disclosure.

### DETAILED DESCRIPTION

Hereinafter, embodiments of the disclosure will be described in detail with reference to the accompanying drawings. In the drawings, the same reference numbers or signs refer to components that perform substantially the same function, and the size of each component in the drawings may be exaggerated for clarity and convenience. However, the technical idea and the core configuration and operation of the disclosure are not limited only to the configuration or operation described in the following examples. In describing the disclosure, if it is determined that a detailed description of the known technology or configuration related to the disclosure may unnecessarily obscure the subject matter of the disclosure, the detailed description thereof will be omitted.

In embodiments of the disclosure, terms including ordinal numbers such as first and second are used only for the purpose of distinguishing one component from other components, and singular expressions include plural expressions unless the context clearly indicates otherwise. Also, in embodiments of the disclosure, it should be understood that terms such as ‘configured’, ‘include’, and ‘have’ do not preclude the existence or addition possibility of one or more other features or numbers, steps, operations, components, parts, or combinations thereof. In addition, in embodiments of the disclosure, at least one of the plurality of elements refers to not only all of the plurality of elements, but also each one or all combinations thereof excluding the rest of the plurality of elements.

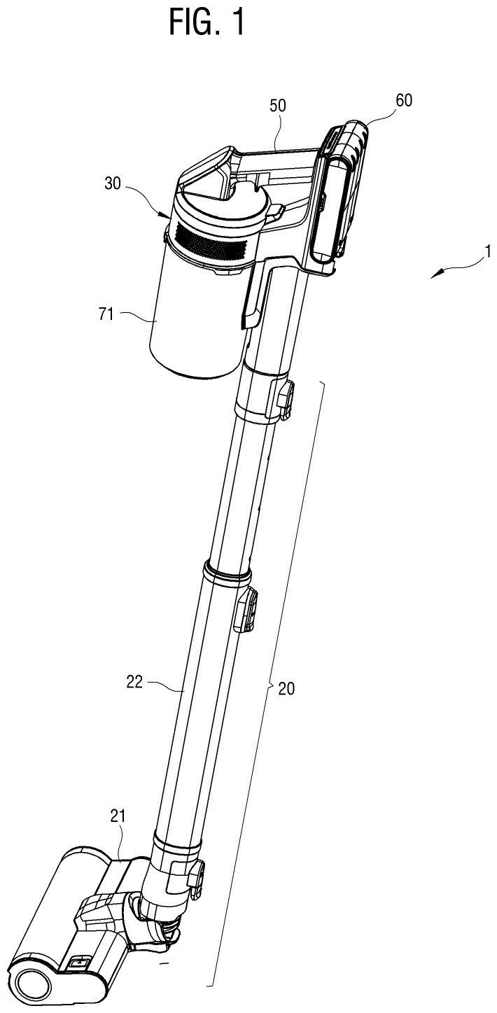

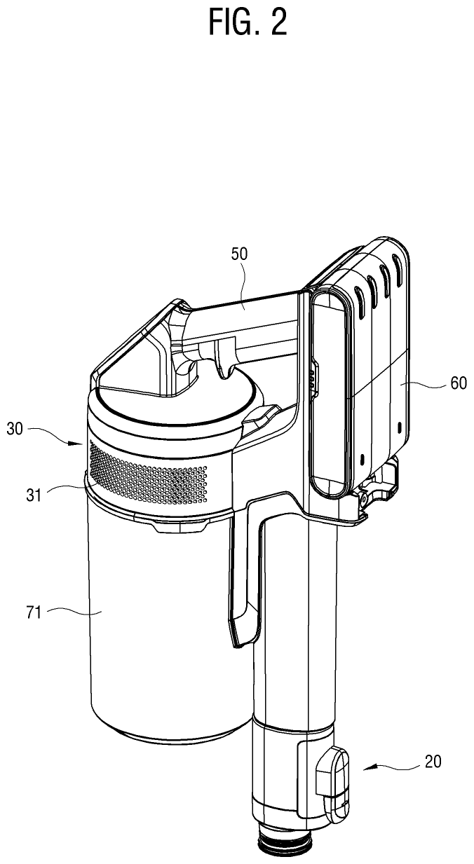

FIG. 1 is a perspective view of a vacuum cleaner 1 according to an embodiment of the disclosure, and FIG. 2 is a perspective view of a body of the vacuum cleaner 1 according to the embodiment of the disclosure.

The vacuum cleaner 1 according to the embodiment of the disclosure may be implemented as a stick type vacuum cleaner. However, the vacuum cleaner 1 according to the embodiment of the disclosure is not limited thereto, and may be implemented as, for example, a handy type vacuum cleaner, a handy-stick type vacuum cleaner, a canister type vacuum cleaner, and an upright type vacuum cleaner. However, in the following description, for convenience of explanation, it is assumed that the vacuum cleaner may be implemented as the stick type vacuum cleaner 1.

The vacuum cleaner 1 according to the embodiment of the disclosure includes a driving unit 10, a suction unit 20, a discharge unit 30, and a filter unit 40.

The driving unit 10 as a driver discharges the air inside the vacuum cleaner 1 to the outside of the vacuum cleaner 1 to lower an air density inside the vacuum cleaner 1, thereby forming a suction force into the vacuum cleaner 1. The driving unit 10 may be implemented with a fan motor or the like, but the implementation method thereof is not limited thereto. The driving unit 10 may further include a control unit that controls the driving unit 10.

The suction unit 20 as a suctioner sucks the outside air with the suction force formed by the driving unit 10. The suction unit 20 may include a suction head 21 that directly contacts a surface to be cleaned to suck foreign objects. The suction head 21 may be provided in a somewhat wider shape so as to be in close contact with the surface to be cleaned. The suction unit 20 may include an extension tube 22 that is adjustable in length. The extension tube 22 may be attached to one end of the suction head 21, so the entire length of the suction unit 20 may be adjusted. The extension tube 22 may be made of a resin or metal material, but the material is not limited thereto. The extension tube 22 may be provided in the form of a flexible hose so as to be freely deformed in a shape.

The discharge unit 30 as a discharger discharges the air sucked into the vacuum cleaner 1 to the outside. The discharge unit 30 may include a plurality of porous holes 31 provided on a plate surface, and in that case, the sucked air may be discharged to the outside of the vacuum cleaner 1 through porous holes 31. However, the implementation method of the discharge unit 30 is not limited thereto.

The filter unit 40 as a filter is provided in the flow path between the suction unit 20 and the discharge unit 30 to separate foreign objects such as dust from the sucked air. The filter unit 40 includes a first filter 41, a second filter 42, and a joint 43. The first filter 41 has a first surface, the second filter 42 has a second surface surrounding the outer circumference of the first surface, and the joint 43 joins the first surface and a seam contacting the second surface. The filter unit 40 may be provided to be detachable from other components. A detailed description of the filter unit 40 of the disclosure will be described later.

The vacuum cleaner 1 according to the embodiment of the disclosure may further include a handle part 50 that enables a user to grip and operate the vacuum cleaner. In addition, the vacuum cleaner 1 according to the embodiment of the disclosure may further include a power supply unit for supplying power to the vacuum cleaner 1 or a battery mounting part 60.

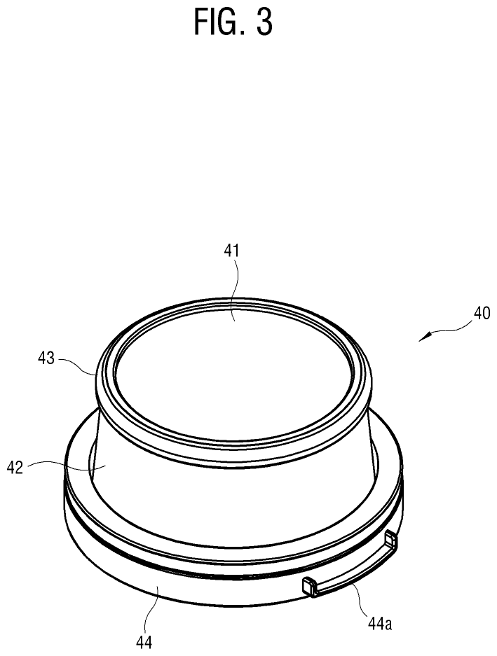

The configuration, effect, and manufacturing method of the filter unit 40 of the vacuum cleaner 1 according to the embodiment of the disclosure will be described with reference to FIGS. 3 to 11.

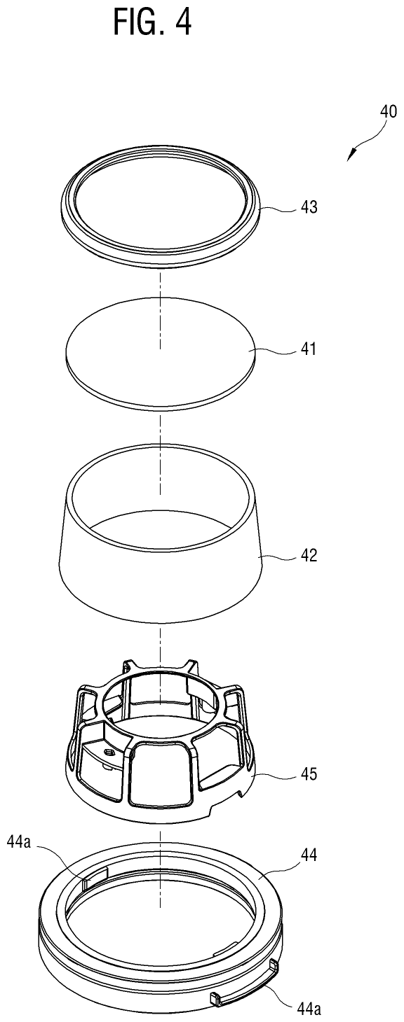

FIG. 3 is a perspective view of the filter unit 40 according to the embodiment of the disclosure, and FIG. 4 is an exploded perspective view of the filter unit 40 according to the embodiment of the disclosure.

The filter unit 40 of the vacuum cleaner 1 according to the embodiment of the disclosure includes a first filter 41 having a first surface, a second filter 42 having a second surface surrounding the outer circumference of the first surface, and a joint 43 that joins the first surface and the seam contacting the second surface.

As the filter unit 40 has such a structure, when the filter unit 40 is provided in the flow path between the suction unit 20 and the discharge unit 30 to separate foreign objects such as dust from the air sucked into the vacuum cleaner 1, the cross-sectional area of the filter unit 40 is widened to include the first surface of the first filter 41 and the second surface of the second filter 42. Accordingly, the use time and washing cycle of the filter unit 40 are lengthened.

That is, accordingly, the time when the user may use the vacuum cleaner 1 without washing the filter unit 40 increases, and thus the user convenience is improved.

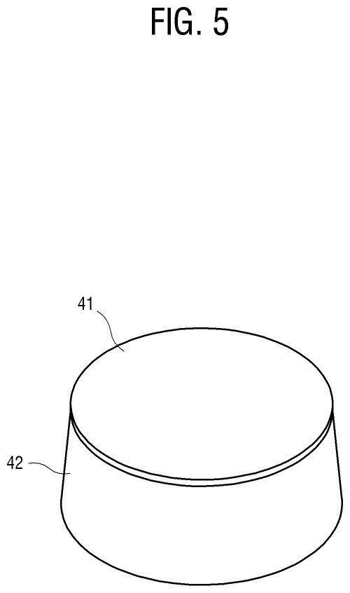

In the filter unit 40 according to the embodiment of the disclosure, it is sufficient that the first surface of the first filter 41 and the second surface of the second filter 42 are joined by seams contacting these two surfaces so that the filter unit 40 including these two surfaces may serve as a filter for filtering the foreign objects in the sucked air, and there are no particular limitations in the form or shape of each surface. For example, as illustrated in FIG. 5, the filter unit 40 may be provided to have the first surface of the first filter 41 having a disk shape, and the second surface of the second filter 42 having a shape partially corresponding to a cylindrical or conical shape. Accordingly, it is possible to maximize the cross-sectional area of the filter unit 40 within a predetermined space. In particular, this is even more so when at least a part of the body of the vacuum cleaner 1 including the filter unit 40 is provided in a cylindrical or conical shape.

The joint 43 of the filter unit 40 according to the embodiment of the disclosure may be formed by being injection-molded of a material having a deformation recovery force of a predetermined or more. That is, the joint 43 may be well bent and may be made of a material having good circular restorability or a material having elasticity or flexibility. For example, the joint 43 of the filter unit 40 may be formed by being injection-molded of a rubber or polyurethane material. However, the material and formation method of the joint 43 are not limited thereto.

Accordingly, the connection part of the first filter 41 and the second filter 42 has the deformation recovery force, and thus may not be affected by the change in the shape of the filter unit 40 while the user of the vacuum cleaner 1 washes the filter unit 40 and may be restored to its original state again even if the shape of the filter part 40 is deformed, so the user may more easily clean the filter unit 40 and the life of the filter unit 40 may increase.

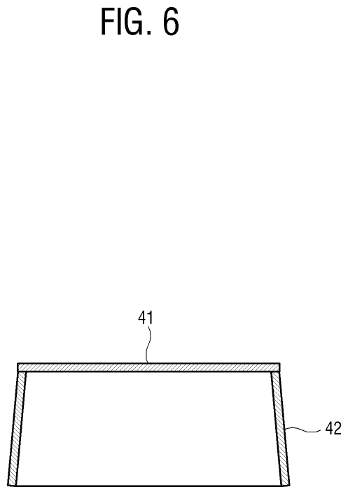

In the first filter 41 of the filter unit 40 according to the embodiment of the disclosure, the edge portion of the first surface may be provided to cover the edge portion of the second surface at the seam contacting the second surface of the second filter 42. For example, as illustrated in FIG. 6 illustrating the cut surface of the filter unit 40 according to the embodiment of the disclosure, the edge portion of the first surface of the first filter 41 of the filter unit 40 according to the embodiment of the disclosure may be disposed on the upper surface of the second surface of the second filter 42 to cover the edge portion (in FIG. 6, upper surface of the second surface) of the second surface contacting the first surface.

Further, the filter unit 40 according to the embodiment of the disclosure may be provided by being injection-molded toward the upper side of the edge portion of the first surface of the first filter 41 that covers the edge portion of the second surface of the second filter 42. Accordingly, the adhesion between the first filter 41 and the second filter 42 is improved.

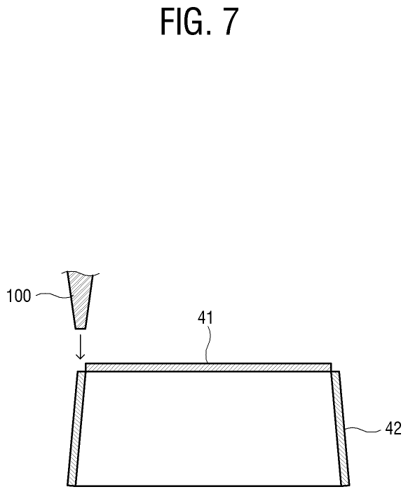

Advantages of the filter unit 40 according to the embodiment of the disclosure prepared according to the arrangement and injection molding method of the first filter 41 and the second filter 42 described above will be described with reference to FIGS. 7 to 10 in comparison with the case of providing the filter unit 40 according to a different method.

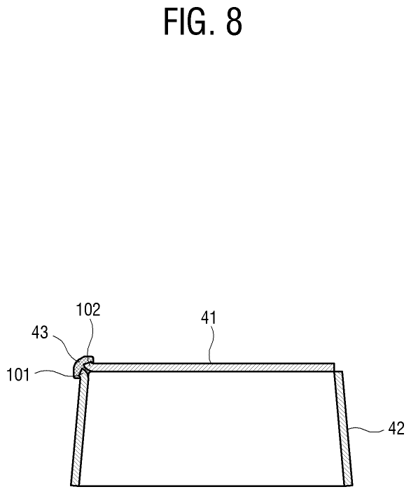

FIGS. 7 and 8 illustrate a process of manufacturing the filter unit 40 by the first method.

In the case of the first method, the joint 43 is formed by injecting (100) a predetermined material toward the seam while the first surface of the first filter 41 and the second surface of the second filter 42 contact each other but the edge portion of the first surface is provided not to cover the edge portion of the second surface of the second filter 42 at the seam contacting the second surface. In this case, as illustrated in FIG. 8, portions 101 and 102 located in the vicinity of the injection-molded portion among the first filter 41 and the second filter 42 may be injection-molded in the form opened by the injection. Accordingly, the adhesion between the first filter 41 and the second filter 42 may be weakened.

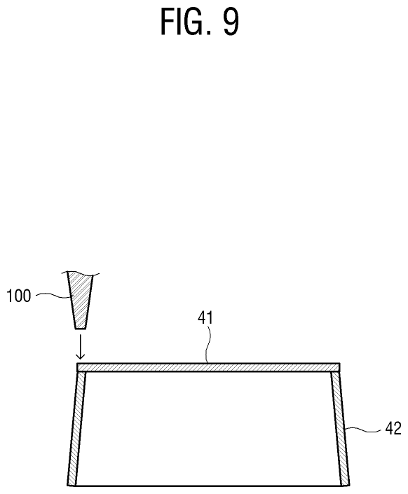

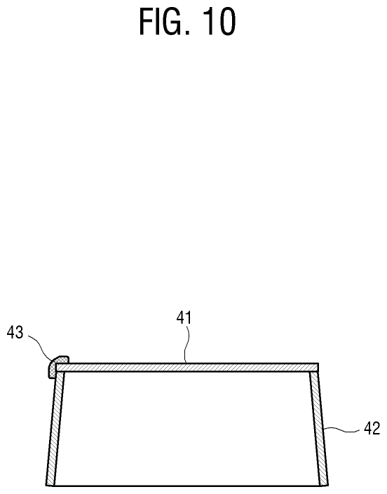

FIGS. 9 and 10 illustrate a process of manufacturing the filter unit 40 by the second method.

In the case of the second method, the joint 43 is formed by injecting (100) a predetermined material toward the seam while the first surface of the first filter 41 and the second surface of the second filter 42 contact each other but the edge portion of the first surface is provided not to cover the edge portion of the second surface of the second filter 42 at the seam contacting the second surface. In that case, as illustrated in FIG. 10 and unlike FIG. 8, without deforming the shape of the first filter 41 and the second filter 42, in particular, without deforming the shape of the portion located near the injection-molded portion among the first filter 41 and the second filter 42, the injection molding may be achieved.

Accordingly, the adhesion between the first filter 41 and the second filter 42 is improved.

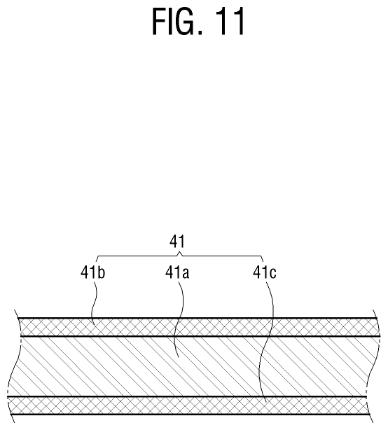

A detailed configuration of the first filter or the second filter will be described with reference to FIG. 11.

In the filter unit 40 according to the embodiment of the disclosure, at least one of the first filter 41 or the second filter 42 may include a micro filter and a mesh member provided on at least one of both surfaces of the micro filter.

Accordingly, the micro filter constituting the filter unit 40 may be supported and protected by the mesh member, so the life of the filter unit 40 increases.

When the filter unit 40 includes the micro filter and the mesh member, the micro filter and the mesh member may be fused to each other by ultrasonic waves.

Accordingly, the contact force between the filter unit and the mesh member is improved.

For example, the first surface of the first filter 41 and the second surface of the second filter 42 may each be provided as the micro filter, and as illustrated in FIG. 11, each of the front and rear surfaces of a first surface 41a of the first filter 41 or a second surface of the second filter 42, which are provided as the micro filter, may be provided with mesh members 41b and 41c mutually fused to the corresponding surface by ultrasonic waves.

Referring back to FIGS. 3 and 4, the filter unit 40 according to the embodiment of the disclosure may further include the frame 44 coupled in a cylindrical shape to the edge portion of the opening formed by the second surface of the second filter 42 on a side opposite to the first surface of the first filter 41. Further, the frame 44 may be injection-molded of a material having a higher strength than the joint 43 of the filter unit 40. The frame 44 may further include a fastening protrusion 44a or a fastening groove, and can be easily fastened to and detached from other components such as the discharge unit 30.

Accordingly, as the filter unit 40 is finished by the frame 44, the filter unit 40 may be more robust, and may also be easily fastened to and detached from other components.

In addition, the filter unit 40 according to the embodiment of the disclosure may further include a support part 45 disposed in a space accommodated by the first filter 41 and the second filter 42. The support part 45 is provided to support the first surface of the first filter 41 in a direction opposite to the air passing through the first surface of the first filter 41, and support the second surface of the second filter 42 in a direction opposite to the air passing through the second surface of the second filter 42.

Accordingly, even if the air sucked through the suction unit 20 passes through the filter unit 40 at a high speed while being discharged through the discharge unit 30, the first surface of the first filter 41 and the second surface of the second filter 42 may maintain their original shapes by the support of the support part 45 to smoothly perform the function as the filter.

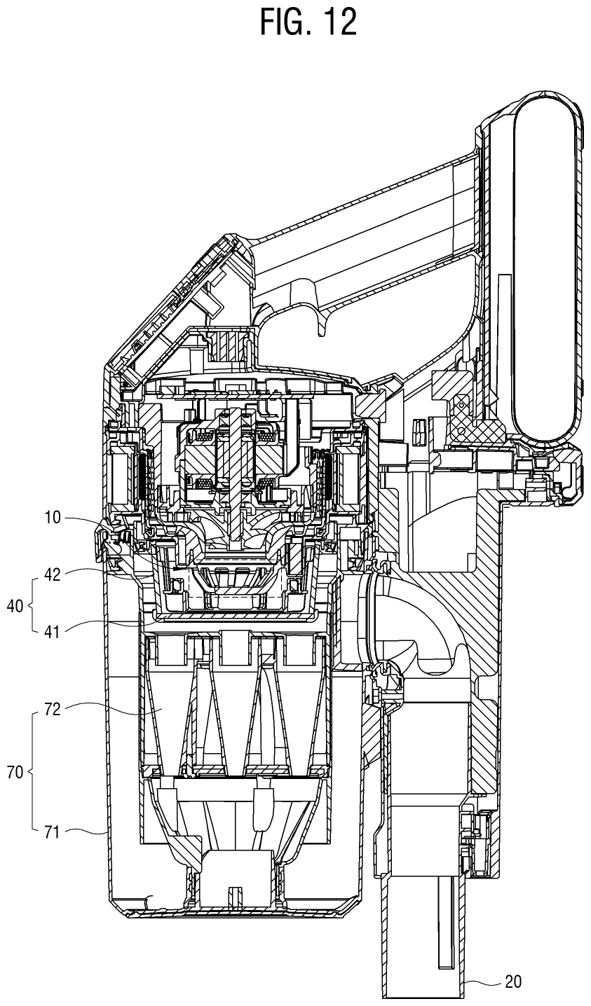

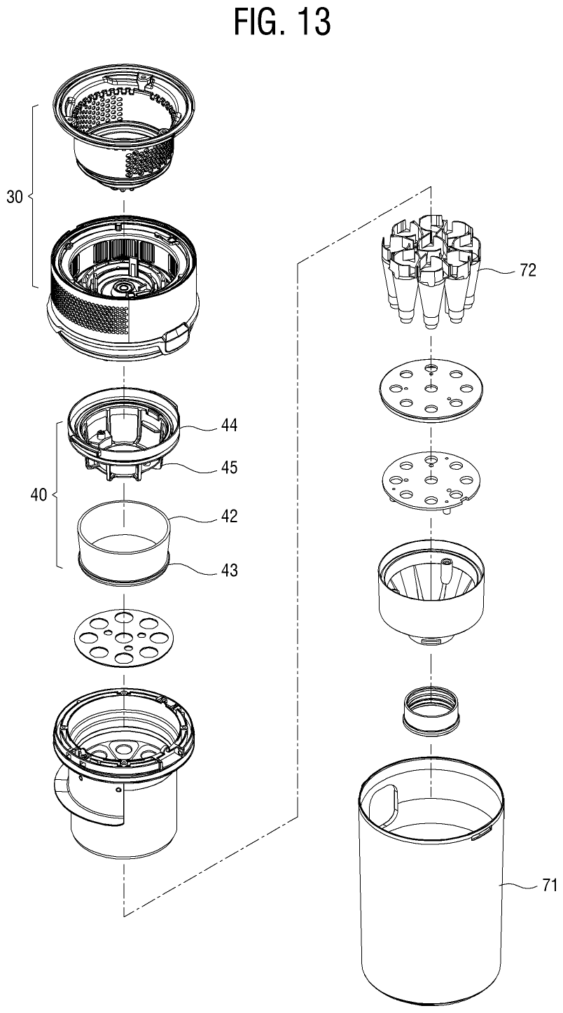

The filter unit 40 according to the embodiment of the disclosure may be provided at a rear end of the dust collector. In other words, the front end of the filter unit 40, that is, the flow path before the air sucked through the suction unit 20 enters the filter unit 40 may be provided with the dust collector, for example, the cyclone dust collector 70. This will be described with reference to FIGS. 12 and 13.

The cyclone dust collector 70 separates air and dust by a centrifugal force by generating a swirling airflow. However, the dust collector of the present embodiment is not limited to the cyclone dust collector 70, and as another example, a dust bag method that filters dust by passing air through a filter bag, or any other known methods that may separate foreign objects may be used.

When the cyclone dust collector 70 is provided, the cyclone dust collector 70 may include a dust bin 71 in which centrifuged dust is accommodated. The dust bin 71 may be detachably coupled to the body of the vacuum cleaner 1, and when coupled, may be sealed.

Furthermore, the cyclone dust collector 70 may include a plurality of cones 72 as an additional dust collector. In that case, the air sucked into the cyclone dust collector 70 is separated from the fine dust by the centrifugal force as the air rotates inside the plurality of cones 72 with a predetermined turning force applied. The cyclone dust collector 70 may further include a spiral flow path guide member for inducing the rotation of the introduced air.

Accordingly, dust having a large size is primarily filtered by the cyclone dust collector 70 in front of the filter unit 40, and thus dust having a relatively smaller size can be secondarily separated from the filter unit 40, so the washing cycle of the filter unit 40 is further reduced.

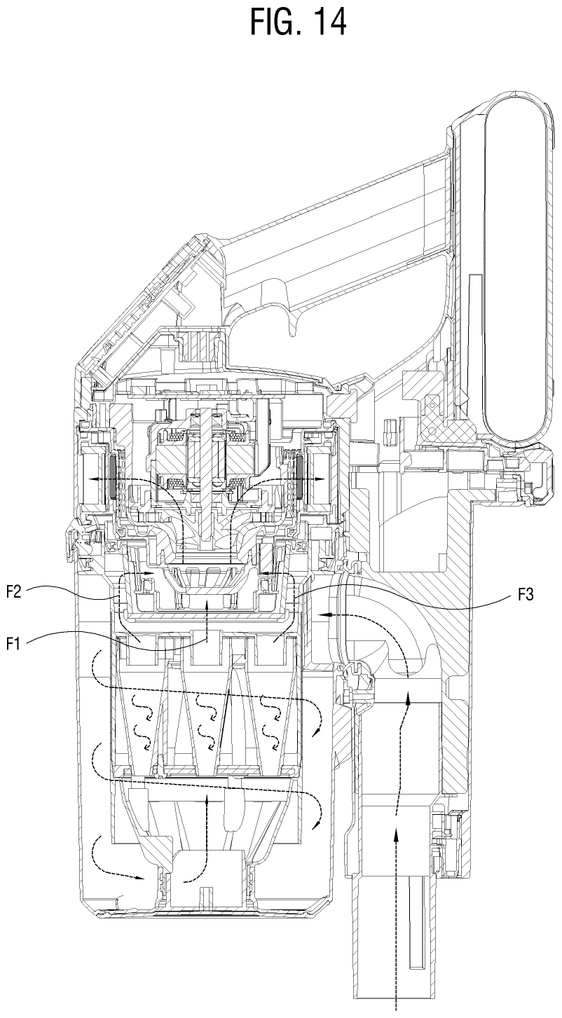

Hereinafter, the operation of the vacuum cleaner 1 according to the embodiment of the disclosure and a flow of air according thereto will be described with reference to FIG. 14. FIG. 14 illustrates an embodiment in which the cyclone dust collector 70 is provided at the front end of the filter unit 40.

When the driving unit 10 is implemented as a fan motor, if the fan motor is driven, the air from the surface to be cleaned is sucked through the suction unit 20 by the suction force generated by the fan motor. When the suction unit 20 includes the suction head 21 and the extension tube 22, the air from the surface to be cleaned is sucked through the suction head 21 and then passes through the extension tube 22 and introduced into the cyclone dust collector 70.

The air introduced into the cyclone dust collector (70) rotates within the cyclone dust collector 70 as a turning force is applied by a spiral flow path guide member or the like. Accordingly, dust, which is heavier than air, is separated radially outward by the centrifugal force and collected in the dust bin 71.

Furthermore, when the plurality of cones 72 are included in the cyclone dust collector 70, the air sucked into the cyclone dust collector 70 is rotated inside the plurality of cones 72 in a state where a predetermined turning force is applied, and as a result, dust is further separated from the sucked air by the centrifugal force.

Air, which is introduced into the suction unit 20 and then passes through the cyclone dust collector 70 and the plurality of cones 72, is introduced into the filter unit 40. Since the filter unit 40 of the disclosure includes the first filter 41 having the first surface and the second filter 42 having the second surface, the air which is introduced into the filter unit 40 and passes through the filter unit 40, may pass through the first filter 41 along a flow path F1 passing through the first surface and may pass through the second filter 42 along flow paths F2 and F3 passing through the second surface. The fine dust included in the air is filtered out while air passes through the filter unit 40. The air, which passes through the filter unit 40, is discharged to the outside of the vacuum cleaner 1 through the discharge unit 30.

As the filter unit 40 of the disclosure includes the first surface of the first filter 41 and the second surface of the second filter 42, the cross-sectional area of the filter unit 40 is larger than that of the existing filter unit, and therefore, the time when the user may use the vacuum cleaner 1 without washing the filter unit 40 increases, thereby improving the user convenience.

1. A vacuum cleaner, comprising:
a driver;
a suctioner configured to suck external air by the driver;
a discharger configured to discharge the sucked air to the outside; and
a filter comprising:
a first filter provided in a flow path between the suctioner and the discharger to separate dust from the sucked air and having a first surface,
a second filter having a second surface surrounding an outer circumference of the first surface, and
a joint configured to join the first surface and a seam contacting the second surface.

2. The vacuum cleaner of claim 1, wherein the first surface of the first filter is provided in a disk shape, and the second surface of the second filter is provided in a cylindrical shape.

3. The vacuum cleaner of claim 1, wherein the first filter is provided so that an edge portion of the first surface covers an edge portion of the second surface at the seam contacting the second surface.

4. The vacuum cleaner of claim 1, wherein the joint of the filter is formed by being injection-molded of a material having a deformation recovery force of a predetermined or more.

5. The vacuum cleaner of claim 1, wherein the joint of the filter is made of a rubber or polyurethane material.

6. The vacuum cleaner of claim 3, wherein the filter is provided by being injection-molded toward an upper side of the edge portion of the first surface of the first filter covering the edge portion of the second surface of the second filter.

7. The vacuum cleaner of claim 1, wherein at least one of the first filter and the second filter includes:
a micro filter; and
a mesh member provided on at least one of both surfaces of the micro filter.

8. The vacuum cleaner of claim 7, wherein the micro filter and the mesh member are fused to each other by ultrasonic waves.

9. The vacuum cleaner of claim 1, wherein the filter further includes, on a side opposite to the first surface, a frame coupled in a circumferential shape to an edge portion of an opening formed by the second surface.

10. The vacuum cleaner of claim 9, wherein the frame is injection-molded of a material having a higher strength than the joint of the filter.

11. The vacuum cleaner of claim 1, wherein the filter further includes a support part disposed in a space accommodated by the first filter and the second filter.

12. The vacuum cleaner of claim 1, wherein the flow path through which the air sucked through the suctioner enters the filter is provided with a cyclone dust collector.
